(19) United States
(12) Patent Application Publication
(10) Pub. No.: US 2023/0347422 A1
(43) Pub. Date: Nov. 2, 2023

(54) ACCESSORY TOOLS

(71) Applicant: MILWAUKEE ELECTRIC TOOL CORPORATION, Brookfield, WI (US)

(72) Inventors: Milorad Marich, Mequon, WI (US); Jonathan G. Winter, Burlington, WI (US); Zachary Bernaden, Milwaukee, WI (US); Bryson Wilcox, Kenosha, WI (US); Nicholas Powers Wilkins, Golden, CO (US); Forrest Nile Getz, Arvada, CO (US); Trevor Patrick Gill, New Berlin, WI (US); Devin Aragon, Westminster, CO (US); Jackson Trent Baker, Monument, CO (US); Garrett Andrew Howard, Indian Hills, CO (US); Grant Christopher Minnihan, Sycamore, IL (US); Sergio Lopez, Denver, CO (US)

(21) Appl. No.: 18/140,697

(22) Filed: Apr. 28, 2023

Related U.S. Application Data
(60) Provisional application No. 63/335,931, filed on Apr. 28, 2022.

(51) Int. Cl. B23B 51/00

(52) U.S. Cl. CPC B23B 51/009; B23B 2251/04; B23B 2251/242

(57) ABSTRACT

A step drill bit including a shank operatively couplable to a tool, a body portion coupled to the shank, the body portion including a tool bit tip and a plurality of progressively sized, axially stacked steps, the body portion defining a hollow cavity, and an inner structure having a plurality of support members extending within the hollow cavity.

### CROSS-REFERENCE TO RELATED APPLICATIONS

This application claims priority to U.S. Provisional Patent Application No. 63/335,931, filed on Apr. 28, 2022, the entire contents of which are incorporated by reference herein.

### FIELD OF INVENTION

The present invention relates to accessory tools, and more particularly to accessory tools for hand tools or power tools.

### SUMMARY

The present application includes, in one aspect, a step drill bit including a shank operatively couplable to a tool, a body portion coupled to the shank, the body portion including a tool bit tip and a plurality of progressively sized, axially stacked steps, the body portion defining a hollow cavity, and an inner structure having a plurality of support members extending within the hollow cavity.

The present application includes, in another aspect, a cutting tool including a shank operatively couplable to a tool, a feed body extending from the shank, a body spaced from and surrounding the feed body, the body including a first end having a plurality of cutting teeth configured to engage a workpiece and a second end opposite the first end, the second end including a base defining a plurality of openings, and a plurality of blades extending between the feed body and the body.

Other aspects of the invention will become apparent by consideration of the detailed description and accompanying drawings.

### BRIEF DESCRIPTION OF THE DRAWINGS

FIG. 1 is a perspective view of a tool bit.

FIG. 2 is an enlarged view of a portion of the tool bit of FIG. 1.

FIG. 3 is a side view of the tool bit of FIG. 1.

FIG. 4 is another perspective view of the tool bit of FIG. 1.

FIG. 5 is a cross-sectional view of the tool bit of FIG. 1.

FIG. 6 is another cross-sectional view of the tool bit of FIG. 1.

FIG. 7 is an enlarged, partial perspective view of a portion of the tool bit of FIG. 1.

FIG. 8 is a perspective view of an angled adapter, according to an embodiment.

FIG. 9 is an exploded view of the angled adapter of FIG. 8.

FIG. 10 is a perspective view of an angled adapter, according to another embodiment.

FIG. 11 is an exploded view of the angled adapter of FIG. 10.

FIG. 12 is a cross-sectional side view of an angled adapter, according to another embodiment.

FIG. 13 is perspective view of the angled adapter of FIG. 12.

FIG. 14 is an exploded view of the angled adapter of FIG. 12.

FIG. 15 is a perspective view of a reaming tool, according to an embodiment.

FIG. 16 is a perspective view of a handle of the reaming tool of FIG. 15 with a blade head removed.

FIG. 17 is a perspective view of a blade head of the reaming tool of FIG. 15.

FIG. 18A is a perspective view of a blade head useable with the reaming tool of FIG. 15.

FIG. 18B is an end view of the blade head of FIG. 18A.

FIG. 19A is a perspective view of another blade head useable with the reaming tool of FIG. 15.

FIG. 19B is an end view of the blade head of FIG. 19A.

FIG. 20 is a perspective view of a reaming tool, according to an embodiment.

FIG. 21 is a perspective view of a handle of the reaming tool of FIG. 20 with a blade head removed.

FIG. 22 is a perspective view of a blade head of the reaming tool of FIG. 20.

FIG. 23 is an exploded perspective view of a reaming tool, according to an embodiment.

FIG. 24 is an exploded perspective view of a reaming tool, according to an embodiment.

FIG. 25 is a perspective view of a cup brush, according to an embodiment.

FIG. 26 is a perspective view of a cup brush, according to another embodiment.

FIG. 27 is a perspective view of a cup brush, according to another embodiment.

FIG. 28 is a perspective view of a cup brush, according to another embodiment.

FIG. 29 is a perspective view of a cup brush, according to another embodiment.

FIG. 30 is a perspective view of a cup brush, according to another embodiment.

FIG. 31 is a perspective view of a cup brush, according to another embodiment.

FIG. 32 is a perspective view of a screwdriver, according to an embodiment.

FIG. 33 is a perspective view of a screwdriver, according to another embodiment.

FIG. 34 is a perspective view of a screwdriver, according to another embodiment.

FIG. 35 is a perspective view of a cutting tool.

FIG. 36 is a front view of the cutting tool of FIG. 35.

FIG. 37A is a perspective view of a cutting tool, according to another embodiment.

FIG. 37B is a front view of the cutting tool of FIG. 37A.

FIG. 38A is a perspective view of a cutting tool, according to another embodiment.

FIG. 38B is a front view of the cutting tool of FIG. 38A.

FIG. 39A is a perspective view of a cutting tool, according to another embodiment.

FIG. 39B is a front view of the cutting tool of FIG. 39A.

FIG. 40A is a perspective view of a cutting tool, according to another embodiment.

FIG. 40B is a front view of the cutting tool of FIG. 40A.

FIG. 41A is a perspective view of a cutting tool, according to another embodiment.

FIG. 41B is a cross-sectional view of the cutting tool of FIG. 41A.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

Additionally, it should be stated the term “additive manufacturing” refers to a process of manufacturing that includes adding material to form a constructed body, such as 3D printing, rather than removing or subtracting material from a blank or template. Some additive manufacturing processes considered in manufacturing the embodiments of the present disclosure include powder bed fusion, material extrusion, material jetting, and the like. Powder bed fusion relates to a process that uses a laser/electron beam to melt and fuse material together, in which the material may range from metals to polymers. Material extrusion relates to a process in which filament (e.g., plastic, PLA, etc.) is heated up to allow for easier extrusion, extruded on an existing piece, and imbedded with different materials to change the filament properties. Material jetting relates to a process in which photosensitive droplets are selectively dropped on thermoset photopolymers and an ultraviolet light is then used to harden the material.

Some such filaments and/or additive materials may include multi material part, 316L stainless steel or brass, galvanized high carbon steel, 17-4 MarkForged onyx composite material (nylon with chopped carbon fiber), PH stainless steel, and the like. Some devices capable of carrying out the 3D printing process include a Fused Deposition Modeling (FDM) printer, DMP Flex 350 printer, Metal Desktop Studio/Shop system (with H900 heat treatment), Markforged Machine, and the like.

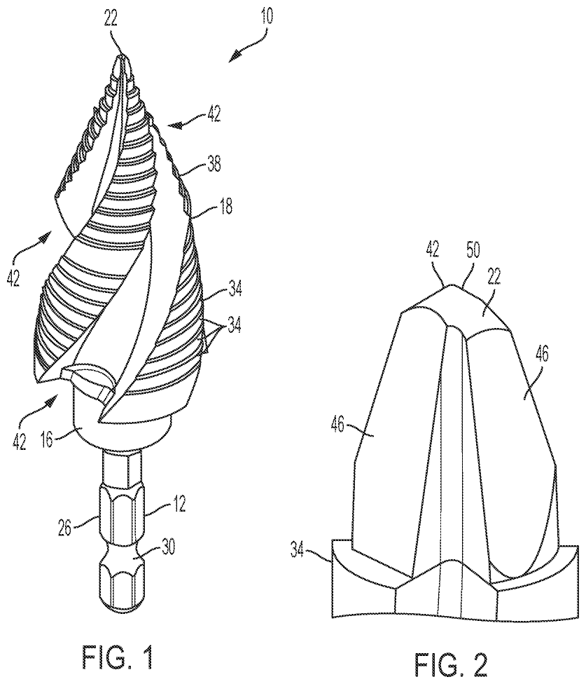

FIGS. 1-3 illustrate a tool bit 10 operatively couplable to a tool or a power tool such as a drill, impact wrench, and the like. The illustrated tool bit 10 is a step drill bit. The tool bit 10 includes a shank 12, a transition portion 16, and a body portion 18. The shank 12 is engages the tool for co-rotation with a chuck of the tool. The transition portion 16 extends between the shank 12 and the body portion 18. The body portion 18 extends from the transition portion 16 to a tool bit tip 22. The tool bit tip 22 is positioned relative to workpiece for performing a cutting operation.

The shank 12 includes a shank body 26 and a shank groove 30. In the illustrated embodiment, the shank body 26 includes a hexagonal cross-section. At least a portion of the shank body 26 is engageable with the tool to rotationally couple the shank 12 to the tool, and the shank groove 30 receives a retention member of the tool (e.g., a detent ball, a clip, etc.) to maintain engagement between the shank 12 and the tool.

As shown in FIG. 1, the body portion 18 includes a plurality of steps 34. The plurality of steps 34 is circumferentially offset from one another along the body portion 18. The steps 34 are offset from one another in a direction of a longitudinal axis of the tool bit 10 (e.g., a centerline extending from an end of the shank 12 to the tool bit tip 22). The steps 34 are axially stacked along an outer surface 38 of the body portion 18. The steps 34 progressively change in size in a direction of the centerline of the tool bit 10. In one embodiment, the steps 34 incrementally increase in size (e.g., a distance the steps 34 extend from the outer surface 38 of the body portion 18). In some embodiments, a distance between adjacent steps 34 is the same. In other embodiments, a distance between adjacent steps 34 varies (e.g., increases, decreases, or irregular). Still, in other embodiments, a distance (e.g., increment) between steps 34 is the same for some of the steps 34 and varies for some of the steps 34.

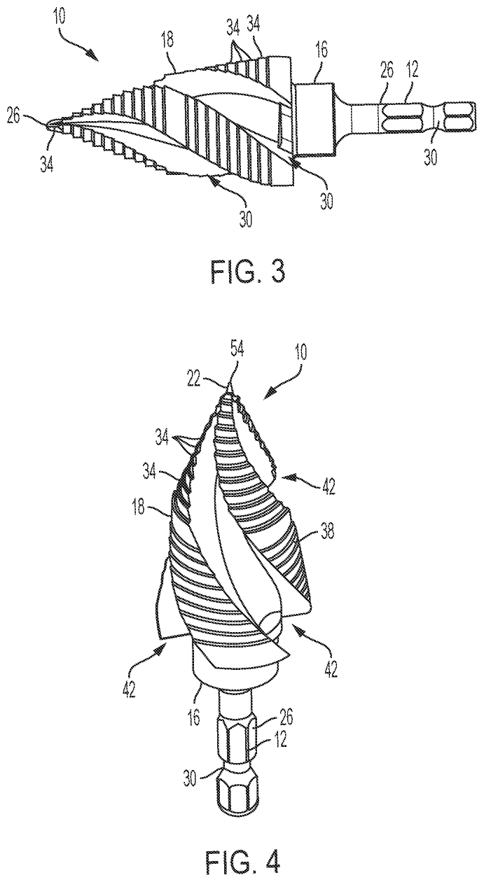

As illustrated in FIGS. 3 and 4, the body portion 18 includes helical flutes 42 that extend along a direction from the transition portion 16 to the tool bit tip 22. The helical flutes 42 are radially offset from each other. The helical flutes 42 extend in a spiral from near the shank 12 to the tool bit tip 22. The body portion 18 may include one, two, three, four, or five helical flutes 42. Each of the helical flutes 42 may provide relief for material removed from a workpiece during operation of the tool bit 10.

With reference to FIG. 2, the tool bit tip 22 includes a plurality of chisel faces 46. As illustrated in FIG. 2, the chisel faces 46 converge to a cutting edge 50 as opposed to a cutting point. As illustrated in FIG. 4, in some embodiments, the chisel faces 46 converge to a cutting point 54. In other embodiments, tool bit tip 22 is a striking tip that converges to a point and is devoid of the chisel faces 46.

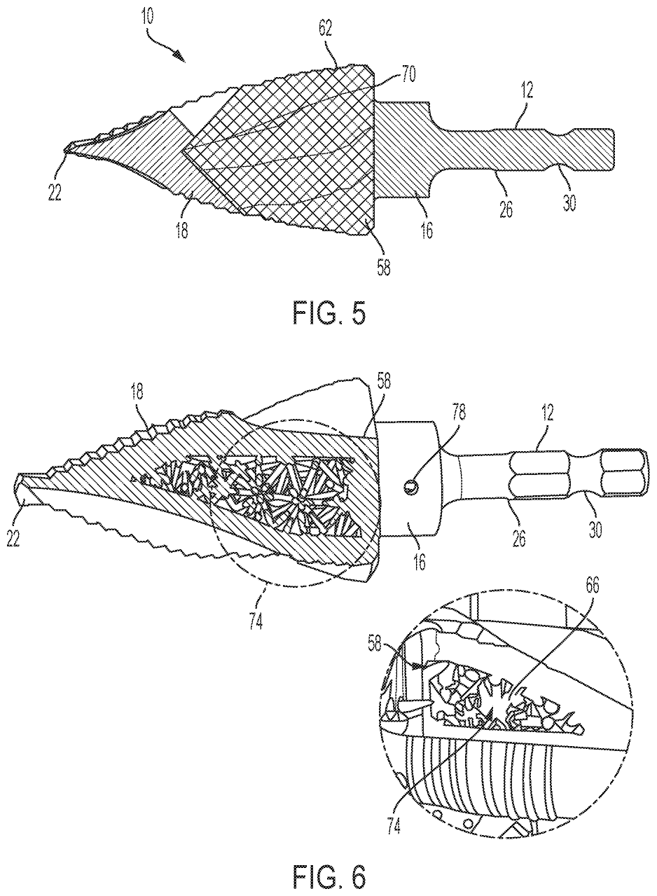

FIGS. 5-7 illustrate the body portion 18 of the tool bit 10 further including a hollow portion or hollow cavity 58. An inner structure 62 (e.g., frame, reinforcement, framework, etc.) is disposed within the hollow cavity 58, such that the body portion 18 includes a reduced amount of material compared to a tool bit formed as a solid body. The inner structure 62 is formed integrally with the body portion 18. Reducing the amount of material in the body portion 18 is achieved through the use of an additive manufacturing process. The additive manufacturing process provides an improved strength to weight ratio for the tool bit 10. The additive manufacturing process also allows the inner structure 62 to be formed as unique geometries to address stress risers within the tool bit 10 during the cutting operation.

As illustrated in FIGS. 5 and 6, the body portion 18 of the tool bit 10 and the inner structure 62 are formed as a single component, piece, or body. The body portion 18 and the inner structure 62 are not formed as separate components, pieces, or bodies. The inner structure 62 includes a plurality of support members 66. The support members 66 are formed integrally with the body portion 18. The support members 66 are arranged within the hollow cavity 58.

The support members 66 may be formed as cylinders, rectangles, or any other suitable shape formed from an additive manufacturing process. In one embodiment, the support members 66 may be formed as interconnected cylinders. As illustrated in FIG. 5, the support members 66 form a grid like pattern or grid 70. In other embodiments, as illustrated in FIG. 6, the support members 66 form a lattice 74 (e.g., crystalline, geodesic, etc.). The lattice 74 may be a uniform pattern. In other embodiments, the lattice 74 may be an irregular pattern. The lattice 74 includes interconnected support members 66.

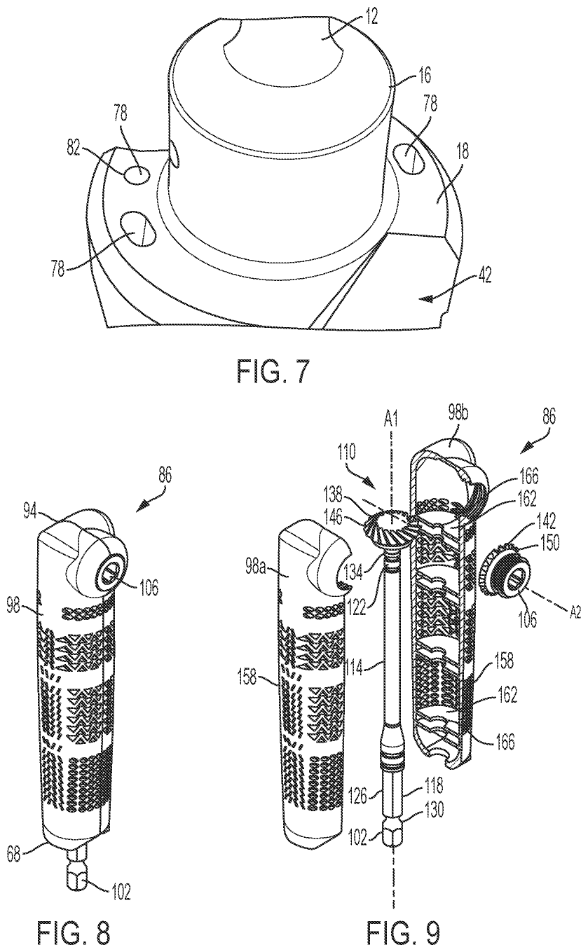

With reference to FIG. 7, the transition portion 16 includes drainage holes or apertures 78 extending through the body portion 18. The apertures 78 may extend from an outer surface 38 of the body portion 18 to the hollow cavity 58 such that a passageway 82 is formed between the hollow cavity 58 and the outer surface 38 of the body portion 18. The hollow cavity 58 is in communication with a point outside the tool bit 10 via the passageway 82. The apertures 78 allow excess material to be cleared out from the hollow cavity 58 during or after the additive manufacturing process.

The tool bit 10 is manufactured through an additive process, such as additive manufacturing. Conventional tool bits are manufactured through extensive machining processes (e.g., subtractive manufacturing, milling, hog out, etc.), which is undesirable for reducing part costs or reducing material waste. The tool bit 10 formed from the additive manufacturing reduces waste or unused material generated during the subtractive manufacturing process. The support members 66 formed within the hollow cavity 58 of the body portion 18 reduces excess weight of the tool bit 10, and also provides the support members 66 through the additive manufacturing process. The support members 66 are integral with the body portion 18 and are not formed as separate parts or pieces from the tool bit 10. The apertures 78 may accommodate removal of any leftover additive material within the hollow cavity 58. In some example constructions, providing the support members 66 and the hollow cavity 58 reduces a weight of the tool bit 10 by approximately 15 percent to 35 percent (e.g., 25 percent) relative to a similar tool bit formed as a solid body.

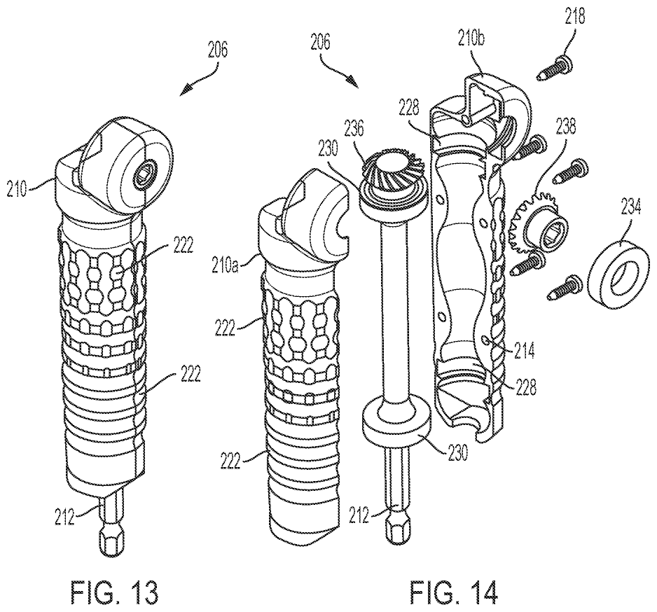

FIGS. 8-14 illustrate various embodiments of angled adapters formed by an additive manufacturing process. FIGS. 8 and 9 illustrate an angled adapter 86 (hereafter “the adapter 86”) configured to be operatively coupled a tool (e.g., drill, impact wrench, etc.) at a first end 90 and to a tool bit at a second end 94. The adapter 86 includes a housing 98 supporting a shank 102 rotatable about a first axis A1, a tool bit receiver 106 rotatable about a second axis A2, and a transmission assembly 80 positioned between the shank 76 and the tool bit receiver 106. The transmission assembly 110 converts the input torque about the first axis A1 to an output torque acting on the tool bit to drive the tool bit to rotate about the second axis A2 (FIG. 9).

The tool applies a torque to the shank 102 to rotate the shank 102 about the first axis A1. The shank 102 is operatively coupled to the transmission assembly 110, such that the transmission assembly 110 converts the input torque about the first axis A1 to an output torque about the second axis A2 to act on a tool bit received in the tool bit receiver 106. The second axis A2 is disposed at an angle relative to the first axis A1. The angle may be approximately 75-120 degrees. More specifically, the angle may be approximately 90-105 degrees (e.g., approximately 90 degrees or approximately 105 degrees). In one embodiment, the angle may be approximately 90 degrees.

As shown in FIG. 9, the shank 102 includes an intermediate portion 114 extending between a tool coupling portion 118 and a transmission coupling portion 122. The tool coupling portion 118 is coupled with the tool. The transmission coupling portion 122 is coupled to the transmission assembly 110. In the illustrated embodiment, the intermediate portion 114, the tool coupling portion 118, and the transmission coupling portion 122 are integrally formed as a single body or shaft. In other embodiments, the shank portions 114, 118, 122 may be formed as separate bodies or shafts that are permanently or releasably secured together.

With continued reference to FIGS. 8 and 9, the tool coupling portion 118 includes a body 126 and a groove 130. The body 126 includes a hexagonal cross section. At least a portion of the body 126 is engageable with the tool to rotationally coupled the shank 102 to the tool. The groove 130 receives a retention of the tool (e.g., a detent ball, a clip, etc.) to maintain engagement between the shank 102 and the tool. Another portion of the body 126 of the tool coupling portion 118 extends into the housing 98 and is rotationally supported by a bearing (not shown).

The tool coupling portion 118 includes a shape having an outer dimension. In some embodiments, the outer dimension of the tool coupling portion 118 refers to a width between two opposite sides, for example, but not limited to, a hexagon, square, or rectangle shape. In other embodiments, the outer dimension of the tool coupling portion 118 refers to a diameter of a cylindrical shape. The intermediate portion 114 of the shank 102 may include a diameter less than the outer dimension of the tool coupling portion 118.

With continued reference to FIG. 9, the transmission coupling portion 122 includes a body 134. The body 134 of the transmission coupling portion 122 includes a hexagonal cross section. The body 134 of the transmission coupling portion 122 is operatively engageable with the transmission assembly 110. The transmission coupling portion 122 is rotationally supported by a second bearing (not shown) such that the shank 102 is further rotationally supported within the housing 98.

As shown in FIG. 9, the transmission assembly 110 includes a first bevel gear 138 supported on the shank 102 and rotatable about the first axis A1, and a second bevel gear 142 supported by the housing 98 and rotatable about the second axis A2. The second bevel gear 142 is coupled to the first bevel gear 138. The second bevel gear 142 may include the tool bit receiver 106 integrally formed therein. The first bevel gear 138 includes a plurality of teeth 146, and the second bevel gear 142 includes a plurality of teeth 150. When assembled, the teeth 146 of the first bevel gear 138 and the teeth 150 of the second bevel gear 142 are intermeshed such that rotation of the first bevel gear 138 about the first axis A1 results in rotation of the second bevel gear 142 about the second axis A2. In other embodiments, the transmission assembly 110 may include other suitable gears or configurations.

In some embodiments, the first bevel gear 138 and the second bevel gear 142 are spiraled gears including angled or slanted teeth. In some embodiments, the first bevel gear 138 is a spiraled bevel gear including angled or slanted teeth, and the second bevel gear 142 is a straight bevel gear including straight teeth. In other embodiments, the first bevel gear 128 is a straight bevel gear including straight teeth, and the second bevel gear 142 is a spiraled bevel gear including angled or slanted teeth. The first bevel gear 138 and the second bevel gear 142 mesh together to transmit rotation of the shank 102 into rotation of tool bit receiver 106.

In the illustrated embodiment, the housing 98 includes a first clamshell portion or first half 98a, and a second clamshell portion or second half 98b coupled together to form the housing 98. In some embodiments, the first half 98a and the second half 98b are formed through an additive manufacturing process, and secured (e.g., snapped, welded, etc.) together to form the housing 98. In other embodiments, the first half 98a and the second half 98b are connected via one or more fasteners.

FIGS. 8 and 9 illustrate the adapter 86 including the housing 98 formed through an additive manufacturing process. The housing 98 includes a plurality of recesses 158 arranged on the first half 98a and the second half 98b. The recesses 158 may be arranged in a lattice to reduce a weight of the adapter 86 and/or reduce the amount of material needed to form the housing 98. The recesses 158 are formed through an additive manufacturing process. As shown in FIG. 9, the housing 98 includes a plurality of inner supports 162 that support the shank 102 within the housing 98. Each inner support 162 defines an aperture 166 configured to receive the shank 102. The inner supports 162 support the shank 102 in the housing 98 during operation of the adapter 86.

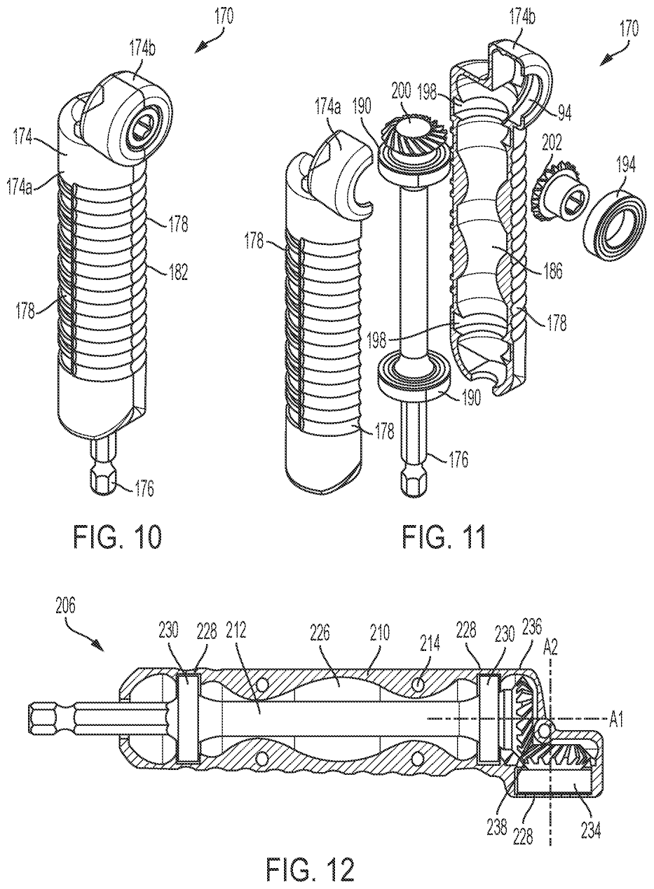

FIGS. 10 and 11 illustrate another embodiment of an adapter 170 formed through an additive manufacturing process. The adapter 170 is similar to the adapter 86 described above, and the following differences explained below. The adapter 170 includes a housing 174 supporting a shank 176. The housing 174 includes a plurality of grips 178 arranged on an outer surface 182 of the housing 174. The grips 178 are arranged on first half 174a and second half 174b of the housing 174.

With continued reference to FIGS. 10 and 11, the housing 174 defines an interior cavity 186 including an interior volume. The interior volume of the interior cavity 186 is variable. The variable interior volume of the interior cavity 186 is achieved through an additive manufacturing process. Portions of the interior cavity 186 may include a larger volume than other portions of the interior cavity 186 to reduce the weight of the housing 174. Portions of the interior cavity 186 may include a smaller volume than other portions of the interior cavity 186 to increase the weight of the housing 174 and/or provide additional reinforcement to the housing 174. For example, the interior volume of the interior cavity 186 proximate shank bearings 190 is smaller compared to the interior volume of the interior cavity 186 at a center portion of the housing 174. A smaller interior volume allows for additional housing 174 material to provide support to the bearings 190. In another example, the interior volume of the interior cavity 186 at the center portion of the housing 174 is larger to reduce the weight of the housing 174.

As shown in FIGS. 10 and 11, the adapter 170 includes shank bearings 190 (e.g., ball bearings) that rotationally support the shank 176 within the housing 174. The adapter 170 includes a first bevel gear 200 and a second bevel gear 202. The first bevel gear 200 is supported by the shank 176. The adapter 170 includes a tool bit bearing 194 the receives the second bevel gear 202. The second bevel gear 202 defines a tool bit receiver that receives a tool bit. The housing 174 defines a plurality of slots 198 configured to receive the shank bearings 190 and the tool bit bearing 194.

FIGS. 12-14 illustrate another embodiment of an adapter 206 formed through an additive manufacturing process. The adapter 206 is similar to the adapter 170 described above, and the following differences explained below. The adapter 206 includes a housing 210 supporting a shank 212. The housing 210 includes a plurality of fastener holes 214 for receiving a plurality of fasteners 218. The housing 210 includes grips 222 arranged along the first half 210a and the second half 210b. The grips 222 may include different shapes or sizes to accommodate a user's hand. For example, some of the grips 222 may be larger than other grips 222. The grips 222 provide a textured surface for a user to grip the adapter 206 during operation of the tool.

With continued reference to FIGS. 12 and 14, the housing 210 defines an interior cavity 226 including an interior volume. The interior volume of the interior cavity 226 is variable. The variable interior volume of the interior cavity 226 is achieved through an additive manufacturing process. Portions of the interior cavity 226 may include a larger volume than other portions of the interior cavity 226 to reduce the weight of the housing 210. Portions of the interior cavity 226 may include a smaller volume than other portions of the interior cavity 226 to increase the weight of the housing 210 and/or provide additional reinforcement to the housing 210. For example, the interior cavity 226 includes a smaller interior volume proximate or at the fastener holes 214 relative to portions of the interior cavity 226 distal the fastener holes 214. A smaller interior volume allows for additional housing 210 material to provide support to the fastener holes 214. In another example, the interior cavity 226 includes a larger interior volume at a center portion of the housing 210 to reduce the weight of the housing 210.

As shown in FIGS. 12 and 14, the housing 210 defines slots 228. The adapter 206 includes shank bearings 230 that rotationally support the shank 212 within the housing 210, and a tool bit bearing 234 that defines a tool bit receiver, although the shank bearings 230 and the bit bearing 234 illustrated in FIGS. 12-14 are reduced in size relative to the shank bearings 190, and bit bearing 194 illustrated in FIGS. 10 and 11. The adapter 170 includes a first bevel gear 236 and a second bevel gear 238. The first bevel gear 236 is supported by the shank 212. The shank bearings 230 and the tool bit bearing 234 are received within the slots 228. In some embodiments, each component of the adapter 206 can be formed by additive manufacturing.

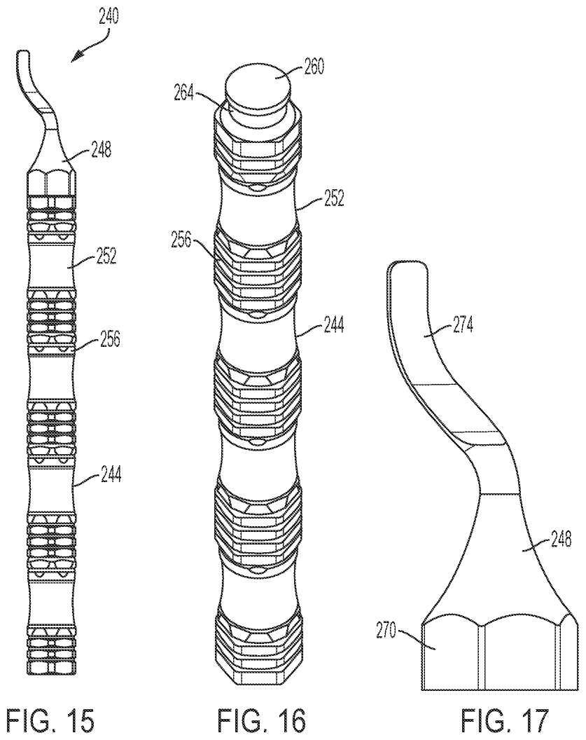

FIGS. 15-24 illustrate various embodiments of reaming tools or pens formed from an additive manufacturing process. FIG. 15 illustrates a reaming tool or pen 240 used to enlarge or finish (e.g., smooth out, clear, etc.) portions of a hole or bore. The pen 240 includes a body or handle 244 and a blade head 248 operatively coupled to the handle 244. The blade head 248 is removably coupled to the handle 244. As such, the blade head 248 may be removed and replaced if it becomes worn or damaged. In operation, a user grasps the handle 244 and runs the blade head 248 around a hole or bore to remove material (e.g., to form a groove, clean a cut of scrap material, etc.).

With reference to FIGS. 15-17, the handle 244 includes groove portions 252 and grip portions 256. The groove portions 252 may be finger grooves separated by the grip portions 256. The handle 244 may also include a mount 260 having a rim 264 configured to selectively receive the blade head 248. Similarly, the blade head 248 includes a corresponding mount portion or base 270 that couples to the mount 260 of the handle 244.

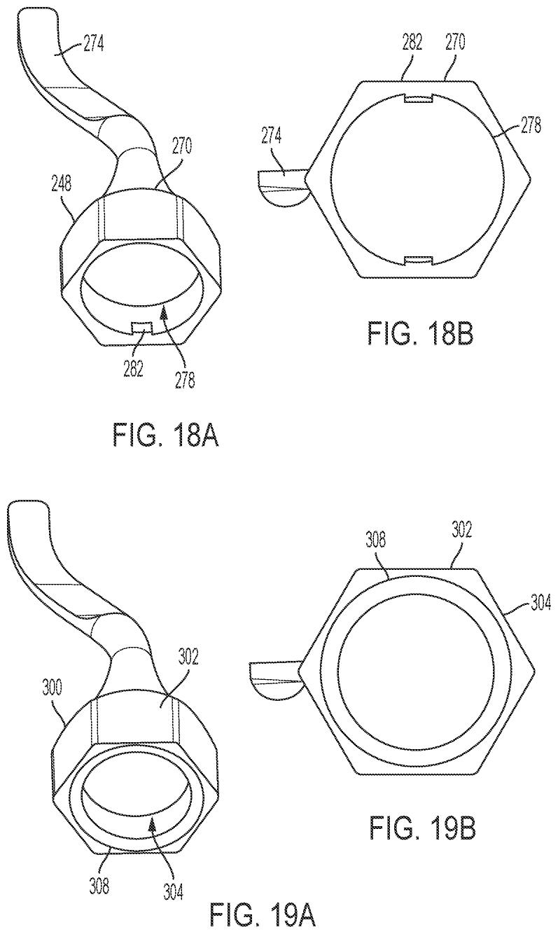

As shown in FIGS. 18A and 18B, the blade head 248 includes the base 270 and a cutting portion or blade 274. The base 270 includes a recess 278 and tabs 282 extending from an inner surface of the base 270. In the illustrated embodiment, the base 270 includes tabs 282, but may include fewer or more tabs 282. The tabs 282 extend into the recess 278. The recess 278 is configured to receive the mount 260 of the handle 244, and the tabs 282 are configured to snap onto the blade head 248 and over the rim 264. The blade head 248 is coupled to the handle 244 via a snap fit connection.

FIG. 19 illustrates another embodiment of a blade head 300 for use with the pen 240 illustrated in FIG. 15. The blade head 300 includes a base 302 defining a recess 304, and a ring tab 308 extending into the recess 304. The recess 304 is configured to receive the mount 260 of the handle 244. The illustrated ring tab 308 extends continuously around a perimeter of the recess 304. The ring tab 308 includes an angled portion configured to compress over the mount 260 and the rim 264 of the handle 244, such that the blade head 300 may be press fit onto the handle 244.

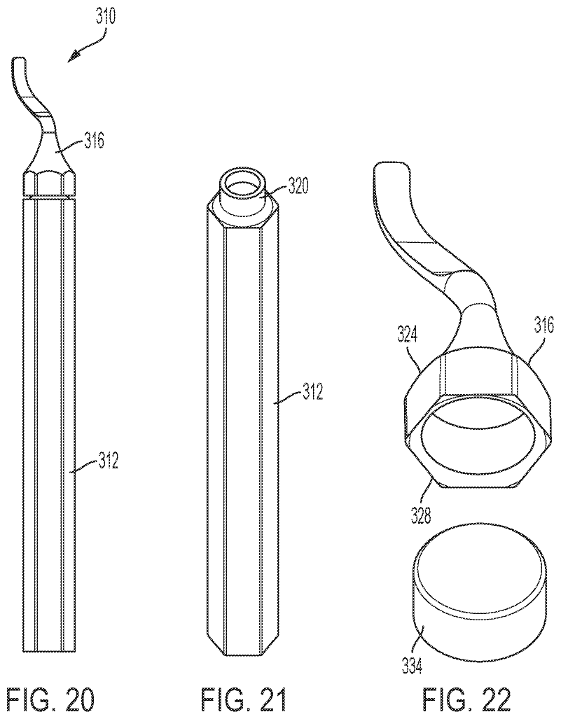

FIGS. 20-22 illustrate another embodiment of a pen 310 including a handle 312 and a blade head 316. The handle 312 includes a generally hexagonal shape. The handle 312 includes a mount 320 extending from the handle 312. The mount 320 includes a generally cylindrical shape. The blade head 316 includes a base 324 defining a recess 328. The mount 320 of the handle 312 may be magnetic. For example, the mount 320 is generally hollow and may receive a magnet 334. The base 324 of the blade head 316 may also be magnetic or received a magnet element (e.g., a metal plate) situated therein, such that the recess 328 receives the mount 320 and the magnet 334 holds the blade head 316 to the handle 312.

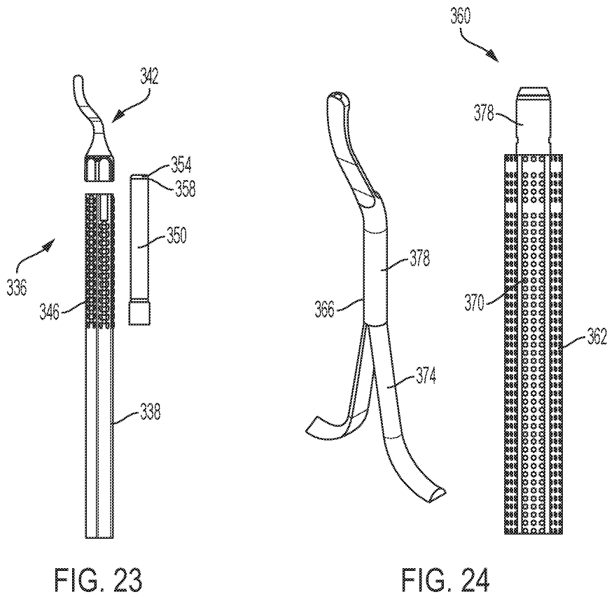

FIG. 23 illustrates another embodiment of a pen 336 including a handle 338 and a blade head 342. The handle 338 includes a generally hexagonal shape. The handle 338 includes grips 346 (e.g., protrusions or apertures). The handle 338 may also support a rotating shaft 350 positioned within the handle 338 and extending therefrom. The shaft 350 includes a mount 354 and a rim 358, such that the blade head 342 engages the rim 358 with a snap/press fitted connection.

FIG. 24 illustrates another embodiment of a pen 360 including a handle 362 and a blade head 366. The handle 362 includes a generally hexagonal shape. The handle 362 includes recesses 370 arranged along a length of the handle 362. The recesses 370 may reduce material and weight. The blade head 366 may include v-shaped spring or clip 374 inserted into the rotating shaft 378. The blade head 366 may be squeezed closed and inserted into the rotating shaft 378. The clip 374 is bias toward an open position such that when the clip 374 is received within the rotating shaft 378, the clip 374 abuts an inner surface of the rotating shaft 378.

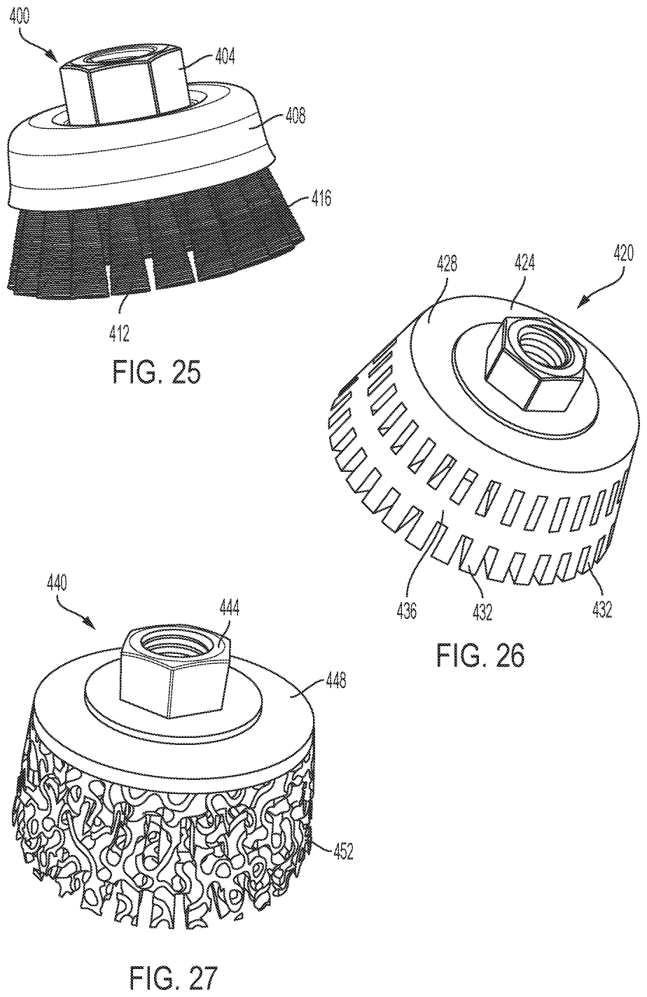

FIGS. 25-31 illustrate various embodiments of cup brushes couplable to a tool or power tool. The cup brushes may be formed from an additive manufacturing process. FIG. 25 illustrates a cup brush or brush 400 that may be attached to a tool (e.g., power tool, drill, etc.). The brush 400 includes a mount 404, a body 408, and a plurality of brush members 412 extending from the body 408. The brush members 412 are separated from adjacent brush members 412. The bush members 412 include a plurality of edges or bristles 416. The brush 400 is formed through an additive manufacturing process. The body 408 and brush members 412 are formed together in a single additive process (e.g., single print or part with multiple passes or layers). In general, the brush members 412 may be formed of different materials depending on desired application, such as rust removal, paint removal, cleaning, scrubbing, etc.

FIG. 26 illustrates another embodiment of a cup brush or brush 420 formed through an additive manufacturing process. The brush 420 includes a mount 424, a body 428, and a plurality of brush members 432. The brush members 432 are joined together by a brush wall 436. The brush members 432 are interconnected or are formed integrally together as one piece or body. The brush members 432 and the brush wall 436 are formed as a single continuous body or piece.

FIG. 27 illustrates another embodiment of a cup brush or brush 440 formed through an additive manufacturing process. The brush 440 includes a mount 444, a body 448, and a plurality of brush members 452. The brush members 452 are interconnected or are formed integrally together as one piece or body. The brush members 452 are formed of a metallic or mesh material including a plurality of curls, veins, or the like to increase a surface area of each brush member 452. The curls, veins, or the like are formed a mesh, and are interconnected together to improve the strength of the brush members 452. The brush members 452 formed as curls or veins are interconnected together to improve the strength of the brush members 452 as compared to a plurality of separated brush members.

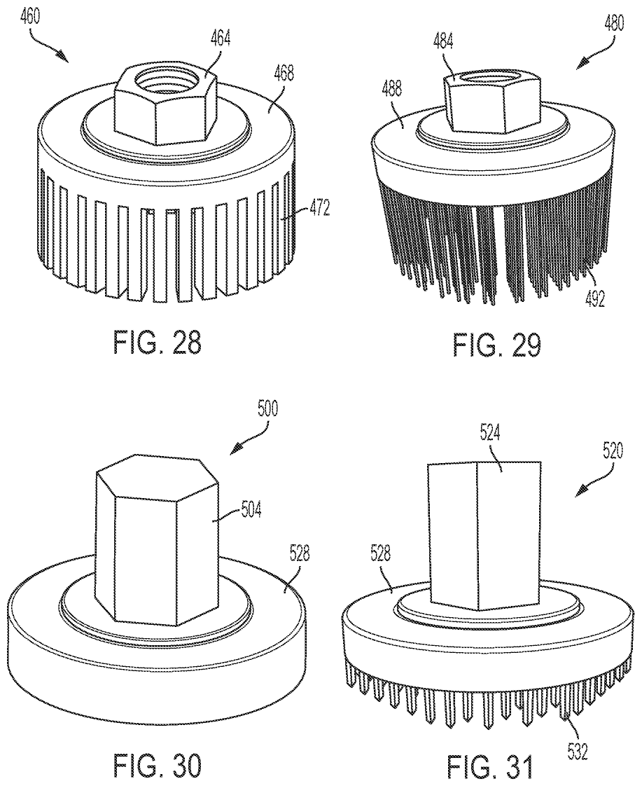

FIGS. 28 illustrates another embodiment of a cup brush or brush 460 formed through an additive manufacturing process. The brush 460 includes a mount 464, a body 468, and a plurality of brush members 472. The brush members 472 are discrete and are spaced from adjacent brush members 472. The brush members 472 are manufactured to be thinner as compared to the other brush member embodiments described in this disclosure. The brush members 472 are thinned with increased flexibility by utilizing a finer filament material. Further, the mount 464 may further be increased (e.g., diameter, size, threaded aperture) to accept a larger connector from the tool. The mount 464 includes various sizes or shapes to accommodate various different tools.

FIG. 29 illustrate another embodiment of a cup brush or brush 480 formed through an additive manufacturing process. The brush 480 includes a mount 484, a body 488, and a plurality of brush members 492. The brush members 492 are discrete and are spaced from adjacent brush members 492. The brush members 492 are manufactured to be thinner as compared to the other brush embodiments described in this disclosure, and specifically brush members 472 of brush 460 illustrated in FIG. 28. The brush members 492 are thinned with increased flexibility by utilizing a finer filament material. Further, the mount 484 may further be increased (e.g., diameter, size, threaded aperture) to accept a larger connector from the tool. The mount includes various sizes or shapes to accommodate various different tools.

FIG. 30 illustrates another embodiment of a cup brush or brush 500 formed through an additive manufacturing process. The brush 500 includes a mount 504, and a body 508. As illustrated in FIG. 30, the mount 504 is larger or taller compared to the other mounts described in this disclosure. The mount 504 extends a greater distance from the body 508 compared to other mounts described in this disclosure.

FIG. 31 illustrates another embodiment of a cup brush or brush 520 formed through an additive manufacturing process. The brush 520 includes a mount 524, a body 528, and a plurality of brush members 532. As illustrated in FIG. 31, the mount 524 is larger or taller compared to the other mounts described in this disclosure. The mount 524 extends a greater distance from the body 528 compared to other mounts described in this disclosure. The brush members 532 are also manufactured with increased flexibility and a thicker material filament to increase the strength of the brush members 532 as compared to the brush members 472 of FIG. 28 and brush member 492 of FIG. 29. The brush 520 includes shorter brush members 532 as compared to other brush members described in this disclosure.

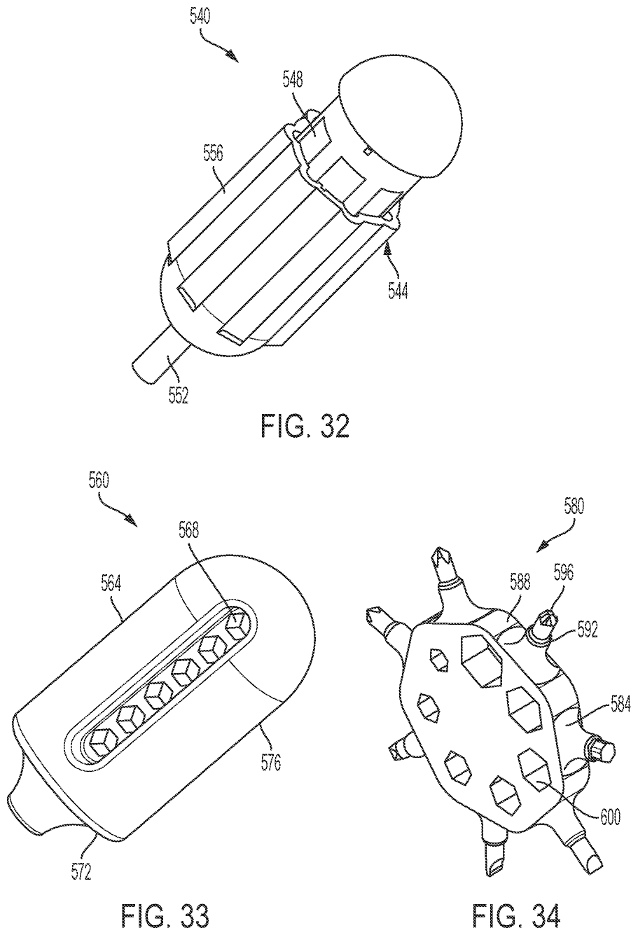

FIGS. 32-34 illustrate various embodiments of screwdrivers formed from an additive manufacturing process. The screwdrivers include tool bit retainers. FIG. 32 illustrates a screwdriver 540 and, particularly, a handle or tool bit retainer of the screwdriver 540. The screwdriver 540 includes a body 544 and a plurality of tool bit receptacles 548 arranged on the body 544. The screwdriver 540 is generally shaped like a pill bottle, in which the body 544 supports a shaft 552 configured to selectively receive a tool bit. The tool bit receptacles 548 are arranged around a circumference of the body 544. The tool bit receptacles 548 are recessed into the body 544 to fully enclose the tool bits within the body 544. The screwdriver 540 further includes a sliding mechanism or sleeve 556 configured to slide over and cover the tool bits received within the tool bit receptacles 548. The screwdriver 540 is formed from an additive manufacturing process such that the body 544 and the shaft 552 is formed as a single piece or body.

FIG. 33 illustrates another embodiment of a screwdriver 560 and, particularly, a handle or tool bit retainer of the screwdriver 560. The screwdriver 560 includes a body 564 and a plurality of tool bit receptacles 568 arranged on the body 564. The tool bit receptacles 568 are arranged in a row along a centerline of the body 564. The tool bit receptacles 568 extend through the body 564 such that when the tool bit receptacles 568 receive a tool bit, the tool bit extends through the tool bit receptacle 568. When the tool bit is inserted within the tool bit receptacle 568, a portion of the tool bit extends outward relative to a first side of the body 564, and a portion of the tool bit extends outward relative to a second side of the body 564. The screwdriver 560 is formed from an additive manufacturing process such that the tool bit retainer 560 is formed as a single body or piece.

FIG. 34 illustrates another embodiment of a screwdriver 580. The illustrated screwdriver 580 is a hand tool. More particularly, the illustrated screwdriver 580 is a unitary body, all-in-one hand tool. The screwdriver 580 includes a body 584 and an outermost face 588 extending around a perimeter of the body 584. The illustrated body 584 is heptagonally-shaped. In other embodiments, the body 584 may have other shapes, such as triangular, square, pentagonal, hexagonal, octagonal, and the like. The screwdriver 580 includes a plurality of tool bit receptacles 592 disposed along the outermost face 588. The tool bit receptacles 592 extend radially relative to a center point of the body 544 (i.e., the tool bit receptacles 592 extend in a direction of a radius). The tool bit receptacles 592 are configured to supports tool bits 596. The tool bit receptacles 592 and the tool bits 596 may be integrally formed by an additive manufacturing process. Alternatively, the tool bit receptacles 592 may removable receive separate tool bits. In some embodiments, the screwdriver 580 includes a plurality of tool bit protrusions 596 extending outward from the outermost face 588. In the illustrated embodiment, one tool bit receptacle 592 and one tool bit 596 extend from each side of the outermost face 588. The tool bits 596 extend radially from the center point of the body 584 (i.e., the tool bit protrusions 596 extend in a direction of a radius). The tool bits 596 are arranged equidistant from each other around the perimeter of the body 584 or along the outermost face 588. In the illustrated embodiment, each tool bit 596 has a different configuration (e.g., flat head, Phillips head, torque head, hex head, etc.). In other embodiments, some or all of the tool bits 596 may have similar configurations.

The body 584 further include a plurality of tool holes 600 (e.g., hex bolt holes) formed therein to provide additional functionality to the screwdriver 580. The tool holes 600 may be used to determine the size of a hex bolt before using a hex bolt wrench. Alternatively, the tool holes 600 may be receive and engage a hex bolt or nut such that the screwdriver 580 itself is used as the wrench. In the illustrated embodiment, the screwdriver 580 includes seven tool holes 600 of different sizes. In other embodiments, the screwdriver 580 may include fewer or more tool holes 600. The screwdriver 580 is formed through an additive manufacturing process such that the screwdriver 580 is formed as one piece or body. For example, the body 584 and the tool bits 596 are formed together as one piece, component, or body.

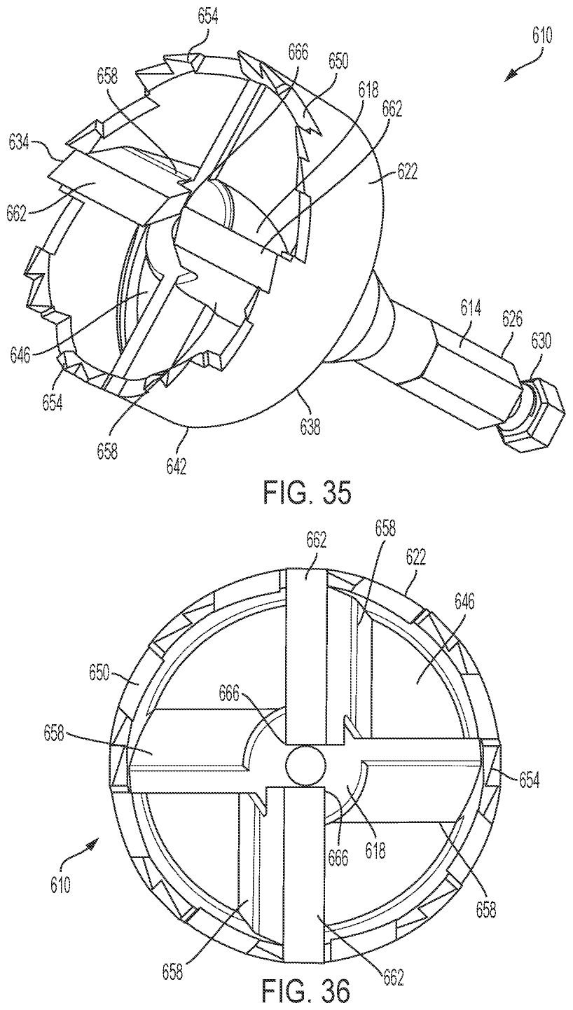

FIGS. 35-41 illustrate various embodiments of cutting tool bits for use with a tool (e.g., power tool, driver drill, screwdriver, etc.). The illustrated cutting tools are self feed bits. FIG. 35 illustrates a cutting tool or bit 610 for use with the tool. The bit 610 includes a shank 614, a feed body 618, and a body 622. The shank 614 is operatively couplable to the power tool for co-rotation with a chuck of the tool. The feed body 618 and the body 622 are configured to be positioned relative to a workpiece for performing a cutting operation.

The shank 614 includes a generally cylindrical shape having a shank body 626 and a shank groove 630. In the illustrated embodiment, the shank body 626 includes a hexagonal cross-section. At least a portion of the shank body 626 is engageable with the tool to rotationally couple the shank 614 to the tool, and the shank groove 630 receives a retention member of the tool (e.g., a detent ball, a clip, etc.) to maintain engagement between the shank 614 and the tool.

The feed body 618 extends from the shank 614. The feed body 618 includes a generally cylindrical shape. The feed body 618 includes a feed body diameter greater than a diameter of the shank 614. The diameter of the feed body 618 provides additional reinforcement to the bit 610. The feed body 618 includes a flat face or surface at an end of the feed body 618. The feed body 618 may also include a central bore for receiving a threaded tip that extends axially from the flat face.

The bit body 622 includes a generally cylindrical shape having a first or workpiece- engaging end 634 and a rearward or second end 638. The first end 634 is positioned relative to the workpiece for performing a cutting operation. The bit body 622 surrounds the feed body 618. In the illustrated embodiment, the bit body 622 extends continuously around an entire perimeter of the feed body 618. In other words, the bit body 622 is a continuous sidewall that forms a complete cylinder. The flat surface of the feed body 618 is adjacent the first end 634 of the bit body 622.

With reference to FIGS. 35 and 36, the bit body 622 includes a base 642 defining a plurality of openings 646 at the second end 638. The openings 646 at least partially facilitate chip removal from the bit body 622. In the illustrated embodiment, the openings 646 form an entirety of the base 642 such that the second end 638 of the bit body 622 is an open end. The bit body 622 includes a rim 650 having a plurality of cutting teeth 654 extending axially outward from the rim 650 (i.e., the cutting teeth 654 extend in a direction of a centerline of the bit 610). The cutting teeth 654 are spaced circumferentially around the rim 650. The cutting teeth 654 may be spaced equally around the circumference of the rim 650. In other embodiments, the cutting teeth 654 may be spaced unequally or irregular around the circumference of the rim 650.

The bit 610 also includes a plurality of ramps 658 extending between the bit body 622 and the feed body 618. The ramps 658 also connect, or support, the bit body 622 to the feed body 618. The ramps 658 extend inwardly from the bit body 622 to the feed body 618. The ramps 658 provide increased reinforcement to the bit body 622 and the feed body 618. As illustrated in FIG. 36, when viewing the bit 610 in a direction perpendicular to the feed body 618, the ramps 658 are angled relative to a direction of rotation of the bit 610. The ramps 658 may be angled in the same orientation relative to a direction of rotation of the bit 610. In other embodiments, the ramps 658 may be angled in different orientations relative to a direction of rotation of the bit 610.

The bit 610 includes blades 662 configured to engage the workpiece (e.g., cutting operation). The blades 662 extend from the ramps 658. The blades 662 are arranged around a circumference of the feed body 618. The blades 662 extend radially outward from the feed body 618 to the rim 650 of the bit body 622. The blades 662 are supported by the bit body 622, the ramps 658, and the feed body 618. The blades 662 extend above a portion of the flat surface of feed body 618 to form a cutting tip or point 666.

As illustrated in FIGS. 35 and 36, the blades 662 are angled relative to the flat surface of the feed body 618. In some embodiments, the blades 662 may be angled in the same orientation relative to a direction of rotation of the bit 610. In other embodiments, the blades 662 may be angled in different orientations relative to a direction of rotation of the bit 610. Further, the number of the blades 662 may be the same as the number of ramps 658. In some embodiments, the number of the blades 662 may be different than the number of ramps 658. In other embodiments, the number of blades 662 may be less than the number of ramps 658.

In one example, as illustrated in FIGS. 35 and 36, the bit 610 includes four ramps 658 arranged around a circumference of the feed body 618. The adjacent ramps 658 are offset from each other about the feed body 618 and are supported by the bit body 622. In the illustrated embodiment, the ramps 658 are equally circumferentially spaced about the feed body 618. In other embodiments, the ramps 658 may be unequally circumferentially spaced about the feed body 618. Two of the ramps 658 include a blade 662 that are each generally angled in a common direction relative to a direction of rotation of the bit 610. The other of the ramps 658 that do not support blades 662 may still be provided for support/strength. As shown in FIGS. 35 and 36, the bit 610 includes four ramps 658 and two blades 662.

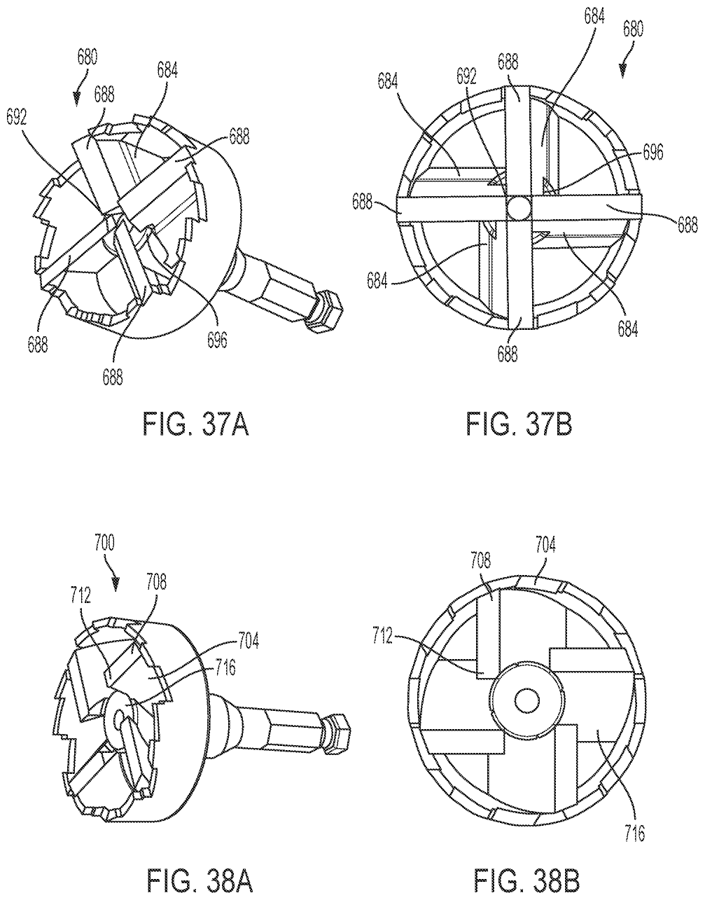

FIGS. 37A and 37B illustrate another embodiment of a bit 680. The bit 680 is similar to the bit 610 described above, and the following differences explained below. The bit 680 includes four ramps 684 and four blades 688, such that each ramp 684 supports a blade 688. The blades 688 are arranged to provide four cutting points 692 all positioned above the flat surface of a feed body 696. The blades 688 are generally angled in a common direction relative to a direction of rotation of the bit 680.

FIGS. 38A and 38B illustrate another embodiment of a bit 700. The bit 700 is similar to the bit 610 described above, and the following differences explained below. The bit 700 includes four ramps 704 and four blades 708, such that each ramp 704 supports a blade 708. The blades 708 are arranged to provide four cutting points 712. The four cutting points 712 are radially offset from the flat surface of the feed body 716.

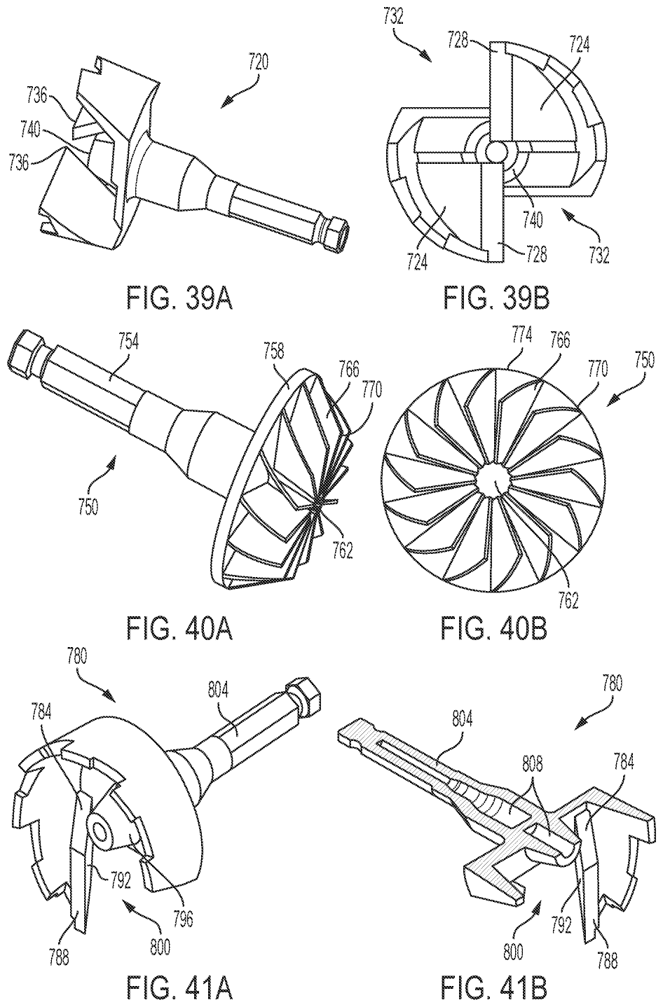

FIGS. 39A and 39B illustrate another embodiment of a bit 720. The bit 720 is similar to the bit 610 described above, and the following differences explained below. The bit 720 includes two ramps 724 and a blade 728 supported on each ramp 724 such that blades 728 are angled into and/or over one of openings 732. The bit 720 includes two ramps 724 and two blades 728. The blades 728 are arranged to provide two cutting points 736 positioned above the flat face of the feed body 740. In the illustrated embodiment, a bit body of the bit 720 is discontinuous. Rather, the bit body includes circumferential segments separated by gaps.

FIGS. 40A and 40B illustrate another embodiment of a bit 750. The bit 750 is similar to the bit 610 described above, and the following differences explained below. The bit 750 includes a shank 754, a bit body 758, a feed body 762, and a plurality of cutting blades 766. The cutting blades 766 are angled in a swept arrangement relative to the feed body 762. Each of the cutting blades 766 includes a cutting point 770 and may be separated by one of the openings 774. In addition, the bit body 758 does not include a sidewall wrapped around the cutting blades 766. Rather, the bit body 758 is a circular plate that supports a rear edge of each cutting blade 758.

FIGS. 41A and 41B illustrate another embodiment of a bit 780 formed from an additive manufacturing process. The bit 780 is similar to the bit 610 described above, and the following differences explained below. The bit 780 includes a single ramp 784 and a single blade 788. The blade 788 is arranged to provide a cutting point 792 positioned radially outwardly from the flat face of the feed body 796 and above the opening 800. The shank 804 and the feed body 796 may include a void 808, such that, in some embodiments, a portion of the bit 780 (e.g., feed body 796) may be generally open ended. The void 808 removes material to reduce the material (and thereby the weight) of the bit 780.

Although the invention has been described in detail with reference to certain preferred embodiments, variations and modifications exist within the scope and spirit of one or more independent aspects of the invention as described.

Various features and advantages of the invention are set forth in the following claims.

What is claimed is:

1. A step drill bit comprising:
a shank operatively couplable to a tool;
a body portion coupled to the shank, the body portion including a tool bit tip and a plurality of progressively sized, axially stacked steps, the body portion defining a hollow cavity; and
an inner structure having a plurality of support members extending within the hollow cavity.

2. The step drill bit of claim 1, wherein the plurality of support members and the body portion are formed as a single piece.

3. The step drill bit of claim 1, wherein the plurality of support members is formed as a plurality of cylinders.

4. The step drill bit of claim 1, wherein the plurality of support members is formed as a lattice structure.

5. The step drill bit of claim 1, further comprising a transition portion positioned between the shank and the body portion, wherein the transition portion defines an aperture in communication with the hollow cavity.

6. The step drill bit of claim 1, wherein the body portion defines a passageway extending from the hollow cavity to an outer surface of the body portion.

7. The step drill bit of claim 1, wherein the body portion includes a helical flute.

8. The step drill bit of claim 1, wherein the tool bit tip includes a plurality of chisel faces, the chisel faces converge to a cutting edge.

9. The step drill bit of claim 1, wherein the tool bit tip includes a plurality of chisel faces, the chisel faces converge to a cutting point.

10. A cutting tool comprising:
a shank operatively couplable to a tool;
a feed body extending from the shank;
a body spaced from and surrounding the feed body, the body including a first end having a plurality of cutting teeth configured to engage a workpiece and a second end opposite the first end, the second end including a base defining a plurality of openings; and
a plurality of blades extending between the feed body and the body.

11. The cutting tool of claim 10, wherein the plurality of openings form the second end as an open second end.

12. The cutting tool of claim 10, further comprising a plurality of ramps extending between and connecting the body and the feed body.

13. The cutting tool of claim 12, wherein the plurality of blades is supported by the plurality of ramps.

14. The cutting tool of claim 12, wherein the body includes a rim extending from the base to the first end, and wherein the plurality of cutting teeth is arranged around a circumference of the rim.

15. The cutting tool of claim 14, wherein the plurality of cutting is spaced equally around the circumference of the rim.

16. The cutting tool of claim 12, wherein a number of blades is less than a number of ramps.

17. The cutting tool of claim 12, wherein a number of blades is equal to a number of ramps.

18. The cutting tool of claim 11, wherein the plurality of blades is angled relative to the feed body.

19. The cutting tool of claim 18, wherein the plurality of blades is angled in a direction of rotation of the cutting tool.

20. The cutting tool of claim 11, wherein the feed body includes a feed body diameter, wherein the shank includes a shank diameter, and wherein the feed body diameter is greater than the shank diameter.
